(19) United States
(12) Patent Application Publication
(10) Pub. No.: US 2010/0061086 A1
(43) Pub. Date: Mar. 11, 2010

(54) BACKLIGHT ASSEMBLY AND METHOD FOR ASSEMBLING THE SAME

(76) Inventors: Kyu-Tae Park, Jung-gu (KR); Jong-Myeong Park, Cheonan-si (KR); Jae-Hwan Chun, Suwon-si (KR); Jong-Ho Won, Suwon-si (KR)

Correspondence Address: Haynes and Boone, LLP;IP Section, 2323 Victory Avenue, SUITE 700, Dallas, TX, 75219, US

(21) Appl. No.: 12/358,193

(22) Filed: Jan. 22, 2009

(30) Foreign Application Priority Data
Sep. 5, 2008 (KR) 2008-87645

(51) Int. Cl. F21V 21/00; B23P 11/00

(52) U.S. Cl. 362/97.2; 29/428

(57) ABSTRACT

An embodiment of a backlight assembly may include an inverter, an inverter substrate, a voltage applying socket, and a lamp. An inverter cover may include sidewalls forming an interior space, and a combining protrusion may be formed on the sidewalls. The inverter substrate may be received by the interior space and may be fixed to the inverter cover by the combining protrusion. The inverter substrate may include an inverter terminal formed on a first surface of the inverter substrate facing outside. The voltage applying socket may include a socket terminal making contact with the inverter terminal, and a voltage terminal connected to the socket terminal. The lamp may be electrically connected to the voltage terminal.

### PRIORITY STATEMENT

This application claims priority under 35 U.S.C. §119 to Korean Patent Application No. 2008-87645, filed on Sep. 5, 2008 in the Korean Intellectual Property Office (KIPO), the contents of which are herein incorporated by reference in their entirety.

### BACKGROUND

1. Technical Field

The present invention relates generally to a backlight assembly and a method for assembling the backlight assembly. More particularly, embodiments of the present invention relate to a backlight assembly used for a liquid crystal display apparatus and a method for assembling the backlight assembly.

2. Related Art

Generally, because liquid crystal display (LCD) apparatuses have a relatively small thickness, light weight, and low power consumption, LCD apparatuses are used for large-sized televisions as well as monitors, laptop computers and cellular phones. An LCD apparatus may include an LCD panel and a backlight assembly. The LCD panel may display an image using the light transmissivity properties of liquid crystal. A backlight assembly may be disposed under the LCD panel to provide light to the LCD panel.

The backlight assembly may include a lamp for emitting the light, a socket electrically connected to an electrode of the lamp, a receiving container for receiving the lamp and the socket, and an inverter electrically connected to the socket and arranged for applying a driving voltage to the lamp. The lamp may be a cold cathode fluorescent lamp (CCFL). A direct illumination-type backlight assembly having a CCFL may include a lamp holder to fix the lamp on a bottom surface of the receiving container.

In assembling the backlight assembly, a soldering process may be used to attach a plurality of lamp holders to a wire connected to the inverter or to attach a plurality of terminals of the lamp holders to a printed circuit board (PCB), to provide a driving voltage to the lamps. Thus, assembling the backlight assembly may require more time than desired and the lamp may be damaged during the soldering process with a frequency higher than is desirable.

In addition, the inverter should be changed after all of the lamps are separated from the lamp holders, thereby reducing the efficiency of assembling the backlight assembly.

### SUMMARY

The present disclosure relates to a backlight assembly capable of being relatively easily assembled and which may be more profitably assembled in an automatic assembly process. The present disclosure also relates to a method for assembling the backlight assembly.

In an example embodiment of a backlight assembly, the backlight assembly may include an inverter cover, an inverter substrate, a voltage applying socket, and a lamp. The inverter cover may include sidewalls forming an interior space, and a combining protrusion formed on the sidewalls. The inverter substrate may be received by the interior space and may be fixed to the inverter cover by the combining protrusion. The inverter substrate may also include an inverter terminal formed on a first surface of the inverter substrate facing outside. The voltage applying socket may include a socket terminal making contact with the inverter terminal, and a voltage terminal connected to the socket terminal. The lamp may be electrically connected to the voltage terminal.

The combining protrusion may protrude from an inner surface of the sidewall toward the interior space. For example, the combining protrusion may include a guide surface protruding diagonally with respect to a sidewall surface of the sidewall, and a fixing surface crossing the guide surface and impinging on or pressing against the first surface of the inverter substrate.

In an alternate embodiment, the combining protrusion may have a bar shape which may protrude vertically with respect to a sidewall surface of the sidewall. In this case, the inverter cover may further include an insertion portion formed between a pair of sidewalls facing each other, such that the inverter substrate may be inserted into the interior space through the insertion portion.

The backlight assembly may further include a receiving container combined with the inverter substrate which may be combined with the inverter cover. The inverter substrate and the inverter cover may be combined with a rear surface of the receiving container, opposite the bottom surface.

In an example embodiment, a method for assembling a backlight assembly may include fixing an inverter substrate to an inverter cover via inserting the inverter substrate into the interior space of the inverter cover. The inverter substrate, which may be fixed to the inverter cover, may be fixed to a receiving container which is combined with a voltage applying socket. A lamp may be fixed to the voltage applying socket. The inverter substrate may be inserted into the inverter cover in a direction substantially the same as the direction in which the inverter substrate is fixed to the receiving container.

In fixing the inverter substrate to the receiving container, the inverter substrate, which may be combined with the inverter cover, may be disposed over the rear surface of the receiving container, such that an inverter terminal formed on a first surface of the inverter substrate may face the rear surface of the receiving container. The inverter terminal may then make contact with a socket terminal of the voltage applying socket via moving the inverter terminal toward the rear surface of the receiving container.

In accordance with an embodiment, an inverter substrate combined with an inverter cover may be combined with a receiving container using an up-down method, such that a backlight assembly may be relatively easily and simply assembled. Thus, the backlight assembly may be automatically assembled. In addition, assembling the backlight assembly may require less time, which may enhance the productivity of a manufacturing process of the backlight assembly.

### BRIEF DESCRIPTION OF THE DRAWINGS

The above and other features and advantages of embodiments of the present invention will become more apparent by describing in detailed example embodiments thereof with reference to the accompanying drawings.

FIG. 1 is an exploded perspective view illustrating an example embodiment of a display apparatus;

FIG. 2A is a perspective view illustrating an example embodiment of a voltage applying socket of FIG. 1;

FIG. 2B is a perspective view illustrating an example embodiment of a voltage applying terminal of the voltage applying socket of FIG. 2A;

FIG. 3 is an exploded perspective view illustrating an example embodiment of a combination between a socket guide and the voltage applying socket of FIG. 1;

FIG. 4A is a perspective view illustrating a first surface of an example embodiment of an inverter substrate of FIG. 1;

FIG. 4B is a perspective view illustrating an example embodiment of a second surface of the inverter substrate of FIG. 4A;

FIG. 5 is a cross-sectional view taken along a line I-I′ of FIG. 1;

FIGS. 6A and 6B are cross-sectional views taken along a line II-II′ of FIG. 1;

FIG. 7 is a cross-sectional view illustrating an example embodiment of a backlight assembly having an inverter cover different from an inverter cover of FIG. 1;

FIG. 8 is a perspective view illustrating an example embodiment of a backlight assembly;

FIG. 9 is a cross-sectional view taken along a line of FIG. 8;

FIG. 10 is an exploded perspective view illustrating an example embodiment of a display apparatus;

FIG. 11 is an exploded perspective view illustrating an example embodiment of a backlight assembly; and

FIGS. 12A and 12B are cross-sectional views illustrating an example embodiment of a method for assembling the backlight assembly of FIG. 11.

### DETAILED DESCRIPTION

Example embodiments are described more fully below with reference to the accompanying drawings. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure will be explained with reference to the accompanying drawings.

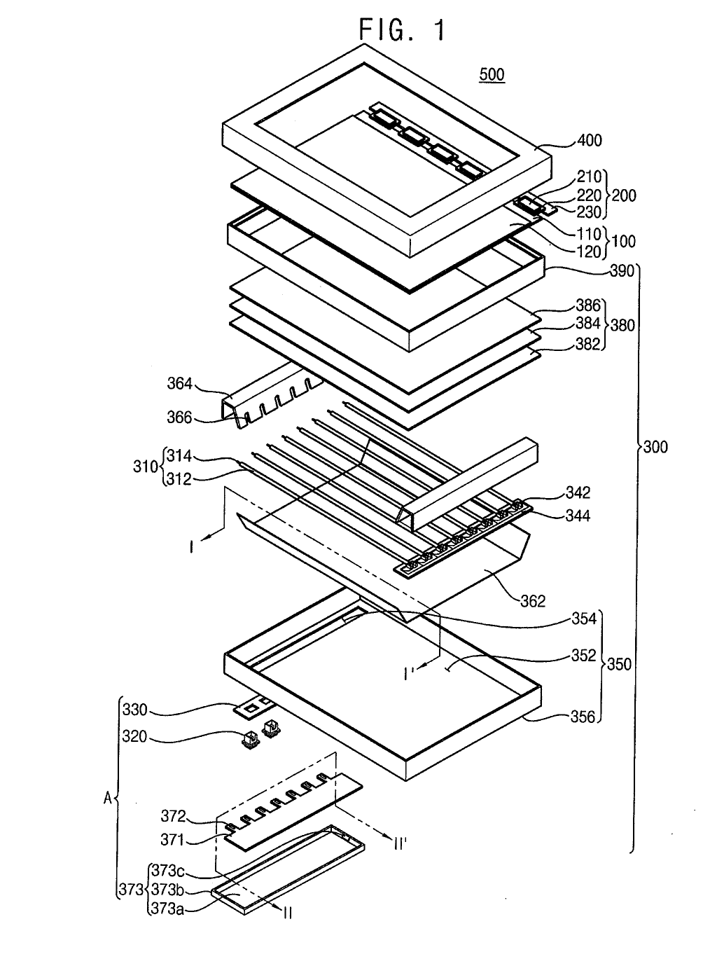

FIG. 1 is an exploded perspective view illustrating an example embodiment of a display apparatus. Referring to FIG. 1, the display apparatus 500 according to the present example embodiment may include a display panel 100, a panel driving unit 200, a backlight assembly 300, and a top chassis 400.

The display panel 100 may display an image using light from the backlight assembly 300 and/or from outside. The display panel 100 may include a display substrate 110, a counter substrate 120 facing the display substrate 110, and a liquid crystal layer (not shown) disposed between the display substrate 110 and the counter substrate 120.

The panel driving unit 200 may provide a gate signal and/or a data signal to the display panel 100, to drive the display panel 100. For example, the panel driving unit 200 may include a driving chip mounted on a signal transmitting substrate 220 and a driving circuit substrate 230 electrically connected to the driving chip 210.

The backlight assembly 300 may be disposed under the display panel 100 to provide the light to the display panel 100. The backlight assembly 300 may include a lamp 310, a receiving container 350, and a power supply module A.

For example, the lamp 310 may generate the light using an external power supply, and may emit the light to the exterior. The lamp 310 may include a lamp tube 312 and a lamp electrode 314. The lamp electrode 314 may be disposed at both ends of the lamp tube 312, and may transmit the power to the lamp tube 312.

The receiving container 350 may receive and support the lamp 310, and may connect the power supply module A with the lamp 310. The receiving container 350 may include a bottom surface 352 supporting the lamp 310. The bottom surface 352 may include an opening 354 formed through the bottom surface 352 of the receiving container 350. The lamp 310 and the power supply module A may be electrically and physically connected to each other through the opening 354.

The power supply module A may include a voltage applying socket 320, an inverter substrate 371, and an inverter cover 372. The power supply module A may further include a socket guide 330.

The voltage applying socket 320 may be combined with the lamp electrode 314 formed at a first end of the lamp tube 312 and may apply the power to the lamp 310. The voltage applying socket 320 may be combined with the socket guide 330.

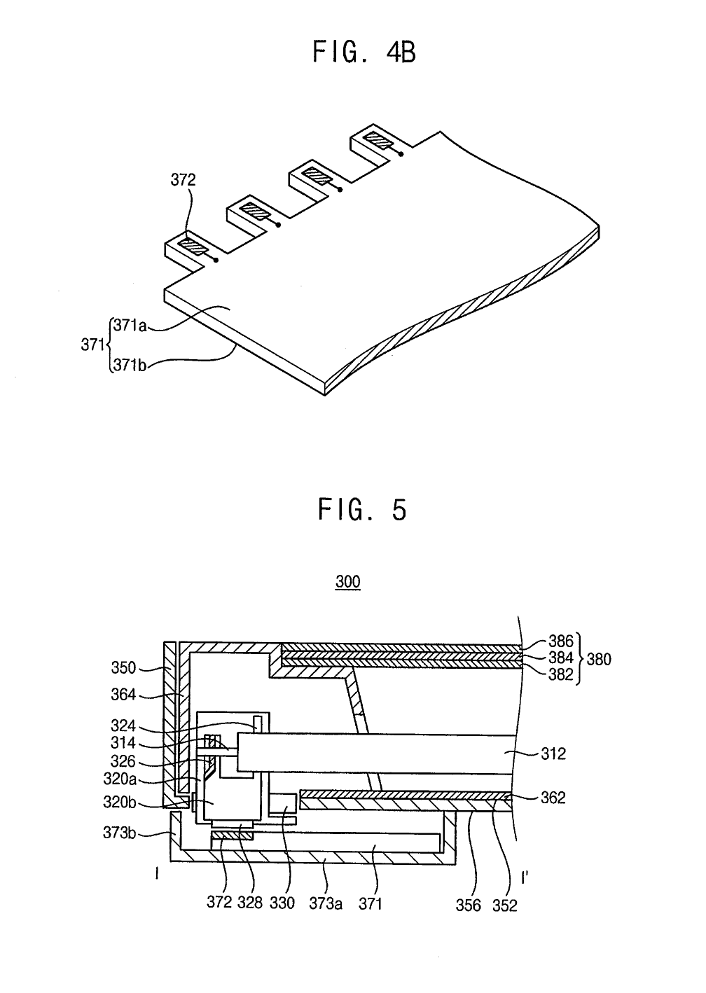

The inverter substrate 371 may be disposed under the receiving container 350. For example, the inverter substrate 371 may be disposed on a rear surface 356 of the receiving container 350. The inverter substrate 371 may make contact with an end portion of the to voltage applying socket 320, thus becoming electrically connected with the voltage applying socket 320. The inverter substrate 371 may include an inverter terminal 372 formed on a first surface 371a as illustrated in FIG. 4A. The first surface 371a of the inverter substrate 371 may be a surface of the inverter substrate 371 facing the rear surface 356. The inverter terminal 372 may be arranged in parallel to one side of the inverter substrate 371. The number of the inverter terminals 372 may be substantially the same as that of the lamps 310.

The inverter cover 373 may cover the inverter substrate 371. The inverter cover 373 may cover a second surface 371b as illustrated in FIG. 4B opposite to the first surface 371a of the inverter substrate 371 and a side of the inverter substrate 371. For example, the inverter cover 373 may include a cover portion 373a and a sidewall 373b.

The cover portion 373a may face the second surface 371b of the inverter substrate 371 to cover the second surface 371b of the inverter substrate 371. The sidewall 373b may enclose an outline of the cover portion 373a to cover the side of the inverter substrate 371.

The sidewall 373b may be substantially perpendicular to the cover portion 373a. When the cover portion 373a has a rectangular shape, the sidewall 373b may be formed along a side of the cover portion 373a, and may thus include four sidewalls 373b. An interior space may be formed inside of the inverter cover 373 by the sidewall 373b, and the inverter substrate 371 may be inserted into the interior space and may be fixed to the inverter cover 373.

The sidewall 373b may include a combining protrusion 373c to combine the inverter cover 373 and the inverter substrate 371. For example, the combining protrusion 373c may guide the inverter substrate 371 so that the inverter substrate 371 is inserted into the interior space of the inverter cover 373. In addition, the combining protrusion 373c may fix the inverter substrate 371 to the inverter cover 373. At least one combining protrusion 373c may be formed at each of a pair of sidewalls 373b facing each other. The combining protrusion 373c may protrude from an inner surface of the sidewall 373b toward the interior space.

The socket guide 330 may guide a plurality of voltage applying sockets 320. The socket guide 330 may be combined with the receiving container 350, and thus the voltage applying socket 320 may be fixed to and arranged in the receiving container 350. The socket guide 330 may be inserted into an opening 354 of the bottom surface 352, so that the receiving container 350 and the socket guide 330 may combine with each other. The socket guide 330 may be inserted from the rear surface 356 of the receiving container 350 opposite to the bottom surface 352 toward the bottom surface 352.

The backlight assembly 300 may further include a ground socket 342, a ground substrate 344, a reflective plate 362, a side mold 364, an optical sheet 380 and a mold frame 390. The ground socket 342 may be combined with the lamp electrode 314 disposed at an opposite side of the lamp electrode 314 which is combined with the voltage applying socket 320. The ground substrate 344 guides a plurality of ground sockets 342. A second end of the lamp 310 may be fixed to the ground substrate 344 by the ground socket 342, and the lamp 310 may be grounded by the ground substrate 344.

Although not shown in the figures, the ground socket 342 and the ground substrate 344 may be omitted, and first and second ends of the lamp 310 may be electrically connected to the voltage applying socket 320. In this case, the voltage applying sockets 320, connected to both ends of the lamp 310, may be connected to the inverter substrate 371, so that the power supply module A may include two inverter substrates 371.

The reflective plate 362 may be disposed between the bottom surface 352 and the lamp 310. The reflective plate 362 may reflect the light that is emitted to a lower side of the lamp 310 to an upper side of the lamp 310.

The side mold 364 may be disposed at both ends of the lamp 310. The side mold 364 may have a predetermined height to support the optical sheet 380. The side mold 364 may include a receiving groove 366 enclosing the end portion of the lamp tube 312. The side mold 364 may be received by the receiving container 350 with the lamp 310.

The optical sheet 380 may be disposed over the lamp 310. The optical sheet 380 may be spaced apart from the lamp 310 by a predetermined distance due to the side mold 364. For example, the optical sheet 380 may include a diffusion sheet 382, a prism sheet 384 and a protective sheet 386.

The mold frame 390 may be disposed under the display panel 100 and may support the display panel 100 and the panel driving unit 200. The mold frame 390 may be disposed over the optical sheet 380 to fix the optical sheet 380 to the side mold 364.

The top chassis 400 may be disposed over the display panel 100 and may be combined with the receiving container 350. The top chassis 400 has an opening corresponding to a display region of the display panel 100 that displays the image, so that the display region may be exposed through the opening.

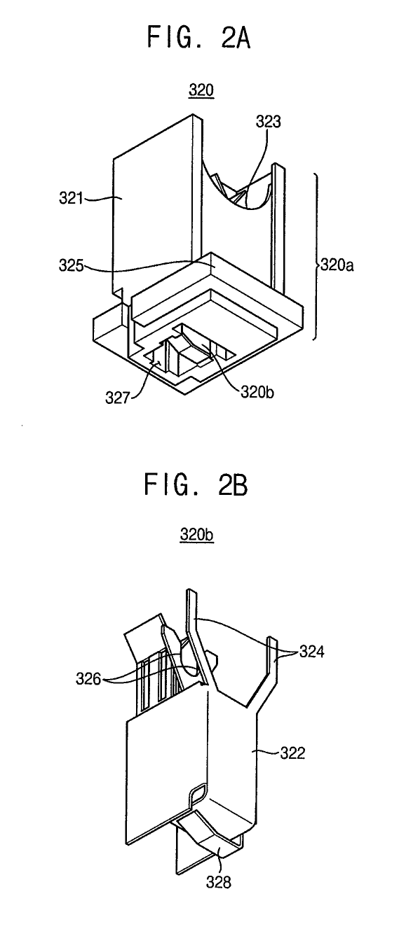

FIG. 2A is a perspective view illustrating an example embodiment of a voltage applying socket of FIG. 1. Referring to FIG. 2A, an example embodiment of a voltage applying socket 320 may include a socket housing 320a and a voltage applying terminal 320b inserted into the socket housing 320a. For example, the socket housing 320a may include a body cover portion 321, a lamp supporting portion 323, a protrusion portion 325, and a terminal exposing portion 327. The socket housing 320a may protect and insulate the voltage applying terminal 320b. For example, the socket housing 320a may include a plastic material.

The body cover portion 321 may cover the voltage applying terminal 320b that may be inserted into the body cover portion 321. For example, the body cover portion 321 may have a rectangular pipe shape including four sidewalls forming a space into which the voltage applying terminal 320b may be inserted.

The lamp supporting portion 323 may support the first end of the lamp tube 312. The lamp supporting portion 323 may be formed at a portion of the body cover portion 321. For example, the lamp supporting portion 323 may be formed at one of the four sidewalls of the body cover portion 321. The shape of the lamp supporting portion 323 may depend on the shape of the lamp tube 312. For example, the lamp supporting portion 323 may have a shape that is divided into both directions with respect to a point of the lamp tube 312 and encloses the lamp tube 312 along a partial circumference of the lamp tube 312. For example, the lamp supporting portion 323 may have a U-shape.

The protrusion portion 325 may have a shape protruding from the body cover portion 321 along a direction. The protrusion portion 325 may be combined with the socket guide 230. The voltage applying socket 320 may be fixed to the socket guide 230 by the protrusion portion 325. The protrusion portion 325 may be disposed between the lamp supporting portion 323 and the terminal exposing portion 327.

The terminal exposing portion 327 may be disposed at a second end of the body cover portion 321. The terminal exposing portion 327 may be an open hole partially exposing the voltage applying terminal 320b.

FIG. 2B is a perspective view illustrating an example embodiment of a voltage applying terminal of the voltage applying socket of FIG. 2A. Referring to FIG. 2B, the voltage applying terminal 320b may include a body portion 322, a lamp fixing portion 324, a voltage terminal 326, and a socket terminal 328.

The voltage applying terminal 320b may be electrically connected to the lamp 310 and may apply power to the lamp 310. For example, the voltage applying terminal 320b may include a conductive material such as a metal.

For example, the body portion 322 may be covered and hidden by the body cover portion 321, so that the body portion 322 may not be visible from outside of the voltage applying socket 320. The shape of the body portion 322 may depend on that of the body cover portion 321. For example, the body portion 322 may have a hexahedral shape.

The lamp fixing portion 324 may be disposed at a first end of the body portion 322. The lamp fixing portion 324 may fix the lamp 310 to the voltage applying socket 320. The lamp fixing portion 324 may be formed along the shape of the lamp supporting portion 323, so that the lamp fixing portion 324 corresponds to the lamp supporting portion 323. The shape of the lamp fixing portion 324 may depend on the shape of the lamp 310 and the shape of the lamp supporting portion 323. For example, the lamp fixing portion 324 may have a U-shape. The lamp fixing portion 324 may support the first end of the lamp tube with the lamp supporting portion 323 and may fix the lamp tube 312 to the voltage applying socket 320.

The voltage terminal 326 may be disposed at the first end of the body portion 322, and may be spaced apart from the lamp fixing portion 324 by a predetermined distance. The voltage terminal 326 may contact the lamp electrode 314 of the lamp 310 to electrically connect the voltage applying socket 320 to the lamp 310. The voltage terminal 326 may include first and second sub-terminals facing each other. The lamp electrode 314 may be inserted between the first and second sub-terminals, such that the voltage applying terminal 326 contacts the lamp electrode 314.

The socket terminal 328 may be disposed at a second end of the body portion 322 opposite to the first end of the body portion 322 where the voltage terminal 326 may be disposed. The socket terminal 328 may contact the inverter terminal 372 of the inverter substrate 371 to electrically connect the voltage applying socket 320 to the inverter substrate 371. The socket terminal 328 may have a shape protruding from the body portion 322 to the outside of the voltage applying socket 320.

For example, the socket terminal 328 may have a U-shape protruding toward the inverter terminal 372. When the voltage applying socket 320 is not connected to the inverter substrate 371, the first end of the socket terminal 328 may be connected to the body portion 322, and the second end of the socket terminal 328 may be spaced apart from the body portion 322. When the inverter substrate 371 presses the socket terminal 328, the inverter terminal 372 may make contact with the socket terminal 328 and the voltage applying socket 320 may be electrically connected to the inverter substrate 371. In this case, the second terminal of the socket terminal 328 may contact the body portion 322.

Accordingly, the second end of the socket terminal 328 may be spaced apart from the body portion 322 by the predetermined distance to enhance the reliability of the contact between the voltage applying socket 320 and the inverter substrate 371. In other words, when the inverter substrate 371 is spaced apart from the voltage applying socket 320 within the predetermined distance, the inverter substrate 371 and the voltage applying socket 320 may be electrically connected to each other. Accordingly, the reliability of the connection between the voltage applying socket 320 and the inverter substrate 371 may be enhanced. In addition, the socket terminal 328 may be completely exposed through the terminal exposing portion 327, so that the inverter substrate 371 and the voltage applying socket 320 may be combined with each other through an up-down movement.

In an alternative embodiment, the socket terminal 328 may be connected to the second end of the body portion 322, and may have a spring shape protruding toward the outside of the voltage applying socket 320. When the inverter substrate 371 is spaced apart from the voltage applying socket 320 within the predetermined distance by the spring shape socket terminal 328, the inverter substrate 371 presses the socket terminal 328 and the inverter terminal 372 makes contact with the socket terminal 328. Accordingly, the inverter substrate 371 and the voltage applying socket 320 may be electrically connected to each other.

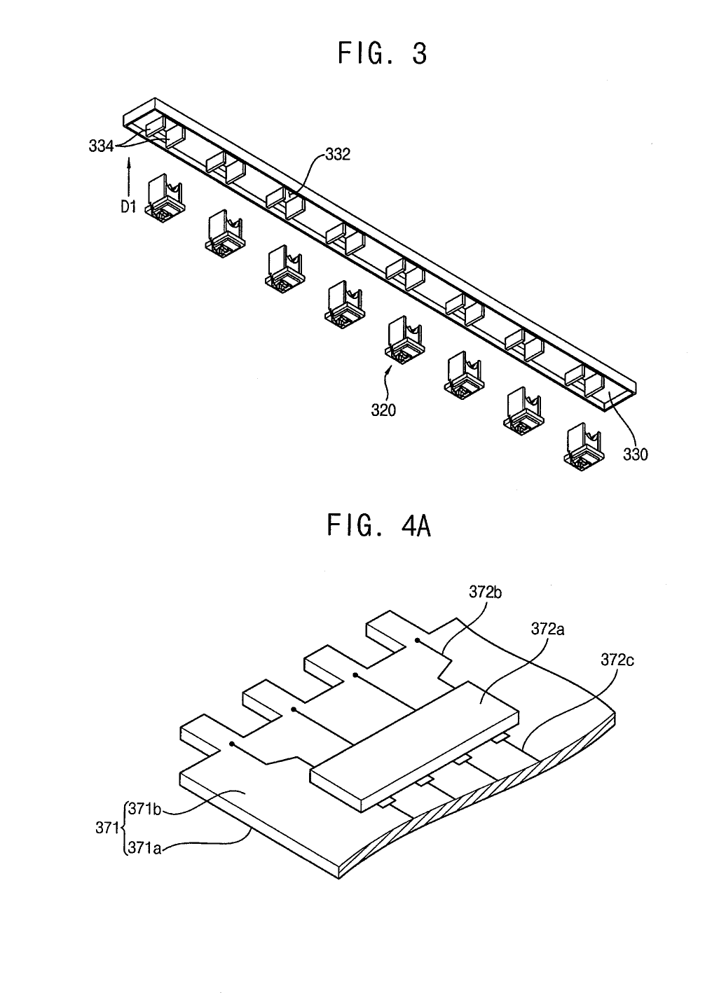

FIG. 3 is an exploded perspective view illustrating an example embodiment of a combination between a socket guide and the voltage applying socket of FIG. 1. A first direction D1 of FIG. 3 is defined as a direction from the backlight assembly toward the display panel of FIG. 1.

Referring to FIG. 3, the socket guide 330 may include a socket insertion hole 332 and a combining portion 334. The voltage applying socket 320 may be inserted through the socket insertion hole 332, and the combining portion 334 may be physically combined with the voltage applying socket 320.

The socket insertion hole 332 may be spaced apart from the socket guide 330 along a longitudinal direction of the socket guide 330. The number of the socket insertion holes 332 may depend on the number of the lamps 310. In addition, the number of the socket insertion holes 332 may depend on the number of the voltage applying sockets 320.

The voltage applying socket 320 may be inserted through the socket insertion hole 332 along the first direction D1. When the voltage applying socket 320 is inserted through the socket insertion hole 332, the socket guide 330 may enclose an outline of the body portion 322 of the voltage applying socket 320. The combining portion 334 may be combined with the protrusion portion 325 of the voltage applying socket 320, to physically connect the socket guide 330 to the voltage applying socket 320. The socket guide 330 combined with the voltage applying socket 320 may be inserted through the opening 354 of the receiving container 350, so that the voltage applying socket 320 may be guided to the receiving container 350.

FIG. 4A is a perspective view illustrating a first surface of an example embodiment of an inverter substrate of FIG. 1. Referring to FIG. 4A, the inverter substrate 371 may include a first surface 371a and a second surface 371b opposite to the first surface 371a. The first surface 371a faces the rear surface 356 of the receiving container 350. A voltage generating circuit part including a voltage generator 372a, an input line 372b and an output line 372c may be formed on the second surface 371b.

The voltage generator 372a may generate the power provided to the lamp 310, and may be electrically connected to the input line 372a and the output line 372c. The input line 372b may input an external signal to the voltage generator 372a. The output line 372c may output the power generated in response to the external signal to the lamp 310. The voltage generator 372a, the input line 372b and the output line 372c that may be formed on the second surface 371b may be covered by the cover portion 373a of the inverter cover 373.

FIG. 4B is a perspective view illustrating an example embodiment of a second surface of the inverter substrate of FIG. 4A. Referring to FIG. 4B, the inverter terminal 372 is disposed on the first surface 371a. The inverter terminal 372 may be electrically connected to the output line 372c formed on the second surface 371b. For example, the inverter terminal 372 and the output line 372c may be electrically connected through a hole formed through the inverter substrate 371. The power generated from the voltage generator 372a is applied to the inverter terminal 372 through the output line 372c. The inverter terminal 372 makes contact with the voltage applying socket 320 and is electrically connected to the voltage applying socket 320, so that the power may be transmitted to the lamp 310.

FIG. 5 is a cross-sectional view taken along a line I-I′ of FIG. 1. Referring to FIGS. 1 and 5, the lamp electrode 314 may be combined with the voltage terminal 326. An end portion of the lamp tube 312 may be mounted on the lamp supporting portion 323 and the lamp fixing portion 324. The socket terminal 328 may be exposed through the terminal exposing portion 327 of the socket housing 320a, and may be disposed toward the rear surface 356 of the receiving container 350. The voltage applying terminal 320b is inserted into the socket housing 320a, so that the socket housing 320a and the voltage applying terminal 320b may be combined with each other by an up-down method.

The voltage applying socket 320 combined with the socket housing 320a and the voltage applying terminal 320b may be inserted through the socket insertion hole 332 along the first direction D1. Accordingly, the voltage applying socket 320 may be combined with the socket guide 330 by the up-down method.

The socket guide 330 may be inserted through the opening 354 along the first direction D1. Accordingly, the socket guide 330 may be combined with the receiving container 350 by the up-down method.

The inverter substrate 371 may be disposed such that the first surface 371a faces the rear surface 356 of the receiving container 350. In this case, the inverter terminal 372 may be disposed to correspond to the opening 354. The inverter terminal 372 may face the socket terminal 328 and may directly contact the socket terminal 328. The inverter substrate 371 may move along the first direction D1 to be combined with the voltage applying socket 320, so that the inverter substrate 371 fixed to the inverter cover 373 may make direct contact with the voltage applying socket 320. Accordingly, the inverter substrate 371 may be combined with the voltage applying socket by the up-down method.

The first surface 371a may be disposed to face the rear surface 356, so that the second surface 371b of the inverter substrate 371 may be disposed to face the cover portion 373a. In addition, the outline of the inverter substrate 371 may be covered by the sidewall 373b. For the voltage generator 372a, for example, the input line 372b and the output line 372c may be covered by the inverter cover 373. The inverter substrate 371 may be inserted into the inverter cover 373 in a direction opposite to the first direction D1. Accordingly, the inverter substrate 371 and the inverter cover 373 may be combined with each other by the up-down method. Although not shown in the figures, the inverter substrate 371 fixed to the inverter cover 373 may be securely combined with the receiving container 350 using an additional screw.

The side mold 364 may be disposed over the first end of the lamp tube 312 and the lamp electrode 314, to cover the first end of the lamp tube 312 and the lamp electrode 314. In addition, the diffusion sheet 382, the prism sheet 384 and the protective sheet 386 are disposed on the side mold 364, and are supported by the side mold 364. The side mold 364 may include a stepped shape having two steps.

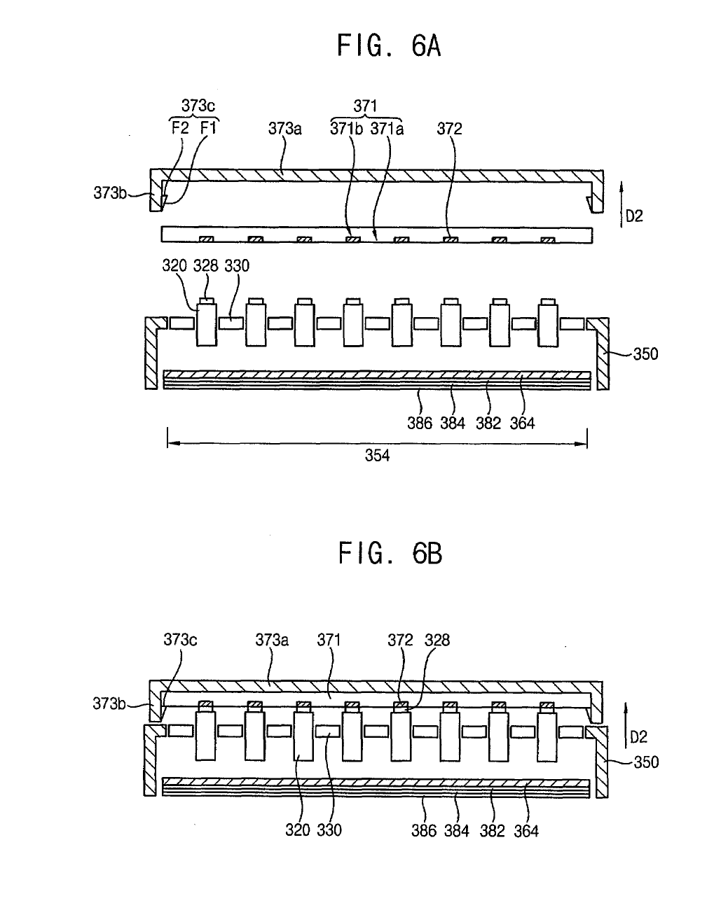

FIGS. 6A and 6B are cross-sectional views taken along a line II-II′ of FIG. 1.

For example, FIG. 6A is a cross-sectional view illustrating the backlight assembly before assembling, and FIG. 6B is a cross-sectional view illustrating the backlight assembly after assembling. In FIGS. 6A and 6B, a second direction D2 is defined as a direction from the display panel toward the backlight assembly of FIG. 1.

Referring to FIG. 6A, the combining protrusion 373c may be formed on each of a pair of sidewalls 373b facing each other, among the four sidewalls 373b of the inverter cover 373. The combining protrusion 373c may be formed on each of the sidewalls 373b that faces both end portions of the inverter substrate 371 extending along a direction in parallel with a direction in which the inverter terminal 372 is arranged. The combining protrusion 373c may be formed on an inner surface of the sidewall 373b. The inner surface may be one surface of the sidewall 373b facing the interior space of the inverter cover 373. The combining protrusion 373c may protrude from the sidewall 373b to the interior space.

The combining protrusion 373c may include a guide surface F1 and a fixing surface F2. The guide surface F1 may have a shape diagonally protruding with respect to a sidewall surface of the sidewall 373b. The fixing surface F2 may cross the guide surface F1, and may face the cover portion 373a.

In an example embodiment, the combining protrusion 373c may be partially formed on the inner surface of the sidewall 373b as described above. In an alternate embodiment, a plurality of combining protrusions 373c may be formed on the inner surface of the sidewall 373b. In addition, the combining protrusion 373c may be formed having a width that extends along a lateral direction of the inner surface of the sidewall 373c.

The second surface 372b may be disposed to face the cover portion 373a, to combine the inverter substrate 371 with the inverter cover 373. The inverter substrate 371 may then move toward the inverter cover 373 along the second direction D2, and the inverter substrate 371 may be inserted into the interior space of the inverter cover 373. A partial circumference of the inverter substrate 371 may make contact with the guide surface F1 and may be inserted into the interior space. The inverter substrate 371 may be easily inserted into the interior space of the inverter cover 373 by the guide surface F1.

Referring to FIG. 6B, the inverter substrate 371 inserted into the interior space may be fixed to the inverter cover 373 by the fixing surface F2. For example, the first surface 371a of the inverter substrate 371 inserted into the interior space of the inverter cover 373 along the guide surface F1 may face the fixing surface F2 and make contact with the fixing surface F2. Accordingly, the inverter substrate 371 may be pressed by the fixing surface F2 and be fixed in the interior space. The inverter substrate 371 and the inverter cover 373 may be combined with each other along the second direction D2 by the up-down method.

Then, the inverter substrate 371, combined with the inverter cover 373, may be moved toward the receiving container 350 along the second direction D2. Accordingly, the inverter terminal 372 may make contact with the socket terminal 328. For example, the inverter substrate 371 and the voltage applying socket 320 may be combined with each other by the up-down method, along the second direction D2, which may be substantially the same as the direction in which the inverter substrate 371 and the inverter cover 373 are combined with each other.

Although not shown in the figures, the voltage applying socket 320 combined with the lamp 310 may be combined with the inverter substrate 371. Alternatively, the lamp may be combined with the voltage applying socket 320 combined with the inverter substrate 371.

In an example embodiment, the inverter cover 373 and the inverter substrate 371 are combined with each other by the up-down method. The inverter substrate 371, fixed to the inverter cover 373, is then combined with the voltage applying socket 320 and the receiving container 350 by the up-down method. Accordingly, the backlight assembly may be assembled along one direction, so that assembling the backlight assembly may be simplified and may require less time. Thus, the backlight assembly may be automatically assembled.

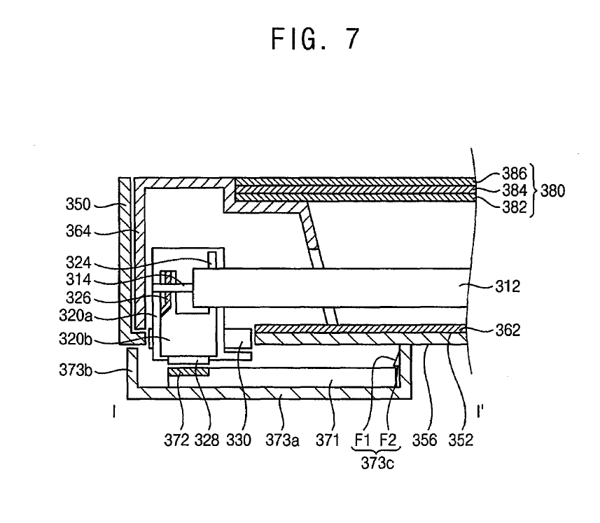

FIG. 7 is a cross-sectional view illustrating an example embodiment of a backlight assembly having an inverter cover different from the inverter cover shown in FIG. 1. Referring to FIG. 7, the combining protrusion 373c of the inverter cover 373 may be further formed on a second edge of the inverter substrate 371 opposite to a first edge of the inverter substrate 371 in parallel with a direction in which the inverter terminal 372 is arranged. For example, the combining protrusion 373c may be formed on the sidewall 373b connecting the sidewalls 373b making contact with both end portions of the inverter substrate 371 along the direction in parallel with a direction in which the inverter terminal 372 is arranged. In addition, although not shown in the figures, the combining protrusion 373c may be formed at the first edge of the inverter substrate 371 where the inverter terminals 372 are formed. Accordingly, the combining protrusion 373c may be formed on at least three sidewalls 373b among the four sidewalls 373b of the inverter cover 373.

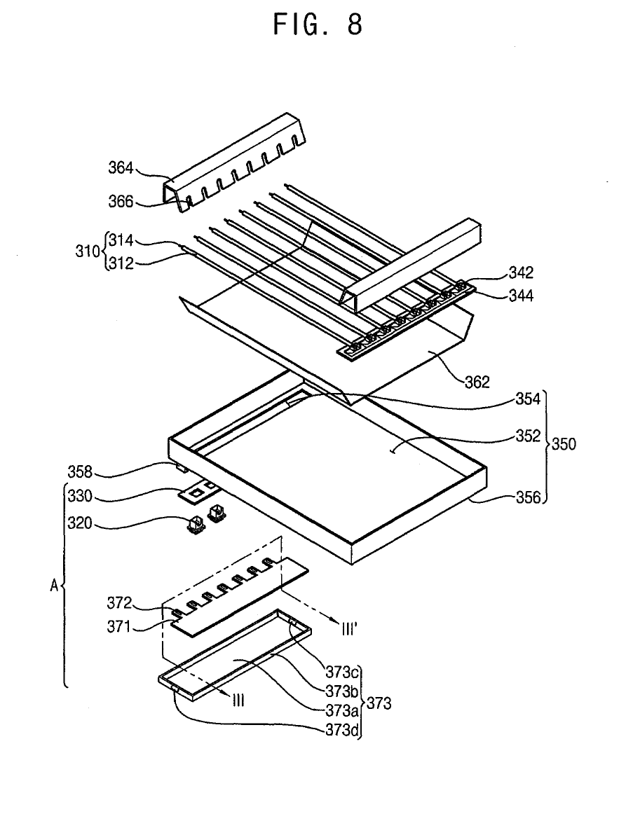

FIG. 8 is a perspective view illustrating an example embodiment of a backlight assembly.

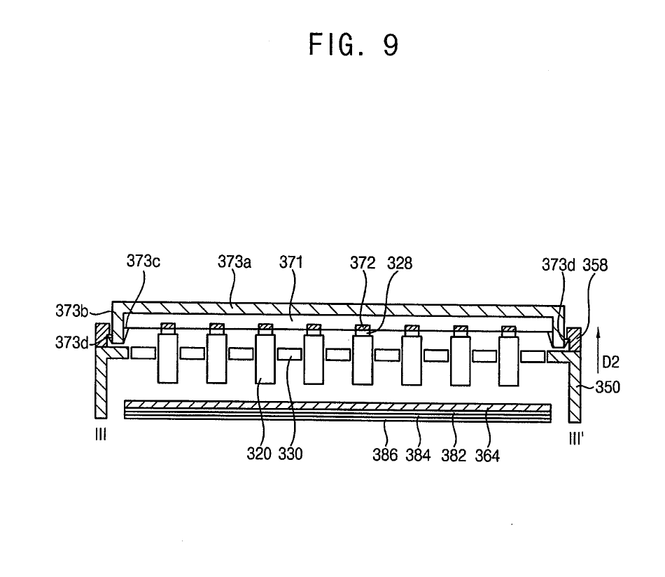

FIG. 9 is a cross-sectional view taken along a line III-III′ of FIG. 8.

Referring to FIGS. 8 and 9, the backlight assembly may be substantially similar to the backlight assembly according to the example embodiment illustrated in FIG. 1. Thus, the same reference numerals are used to refer to the same or like parts as those described in the first example embodiment and any further repetitive explanation concerning the above elements will be omitted.

Referring to FIGS. 8 and 9, the inverter cover 373 may include a cover portion 373a, a sidewall 373b, a combining protrusion 373c, and a fixing protrusion 373d.

The cover portion 373a may cover the inverter substrate 371, and the sidewall 373b may be connected to the cover portion 373a to define an interior space. When the cover portion 373a has a rectangular shape, the inverter cover 373 may have four sidewalls 373b. The combining protrusion 373c may be formed on each of the inner surfaces of at least two sidewalls 373b among the four sidewalls 373b.

The fixing protrusion 373d may be formed on an outer surface of the sidewall 373b opposite to the inner surface of the sidewall 373b. The fixing protrusion 373d may protrude from the outer surface toward the outside of the inverter cover 373. The inverter cover 373 may be securely combined with the receiving container 350 by the fixing protrusion 373d.

In an example embodiment, the receiving container 350 may include a bottom surface 352 having an opening 354, a rear surface 356, and a hook protrusion 358. The hook protrusion 358 may be formed on the rear surface 356. The hook protrusion 358 may be formed around the opening 354. The hook protrusion 358 may be formed on areas of the rear surface 356 where the sidewalls 373b of the inverter cover 373 are disposed. The fixing protrusion 373d, when inserted into the hook protrusion 358, may be constrained from separating from the hook protrusion 358, because the fixing protrusion 373d is hooked by the hook protrusion 358.

Accordingly, when the inverter cover 373 is combined with the receiving container 350 by the up-down method, the inverter cover 373 and the receiving container 350 are relatively easily and securely combined with each other by the hook protrusion 358 and the fixing protrusion 373d. In addition, the inverter cover 373 and the receiving container 350 may be more securely combined with each other by a screw (not shown).

Although not shown in the figures, the fixing protrusion 373d may be formed on all four sidewalls 373b along an outer surface of the sidewalls 373b, and the hook protrusion 358 may be formed on the rear surface 356 around the opening 354 corresponding to the fixing protrusion 373d.

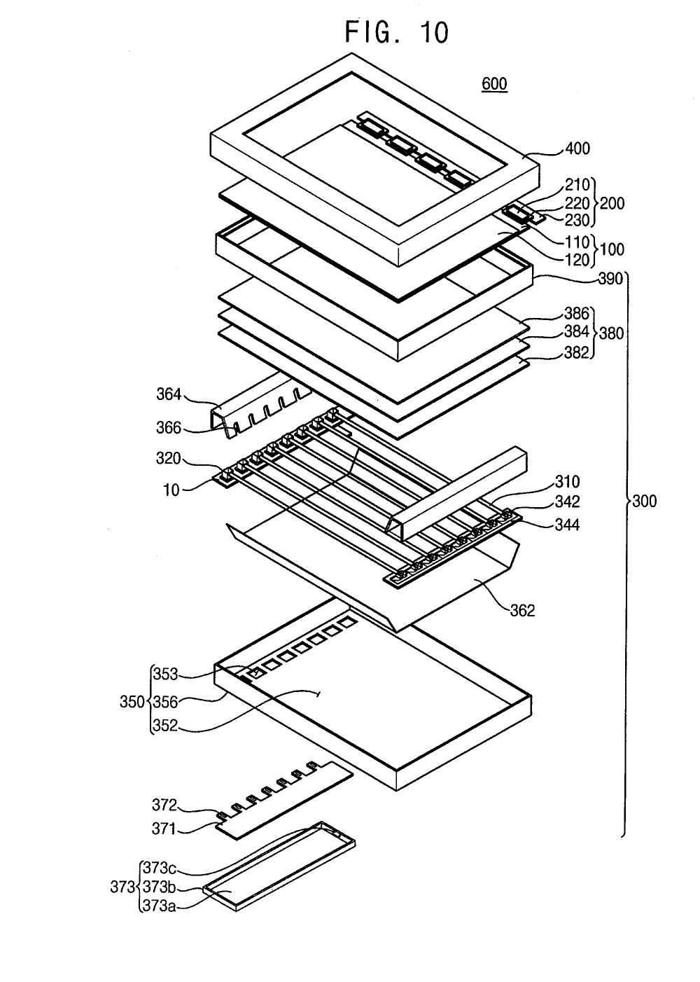

FIG. 10 is an exploded perspective view illustrating an example embodiment of a display apparatus according to a third example embodiment of the present invention. The display apparatus 600 of FIG. 10 may be substantially similar to the display apparatus 500 shown in FIG. 1, except for a socket guide 10 and an opening 353 of the receiving container 350. The display apparatus 600 may include a voltage applying socket substantially similar to the voltage applying socket 320 described with reference to FIGS. 2A and 2B. Thus, the same reference numerals are used to refer to the same or like parts as those described in the first example embodiment and any further repetitive explanation concerning the above elements will be omitted.

Referring to FIG. 10, in an example embodiment of a display apparatus 600, the socket guide 10 may guide a plurality of voltage applying sockets 320 to the receiving container 350. The socket guide 10 may move from an upper portion of the receiving container 350 toward the bottom surface 352 of the receiving container 350 to combine with the receiving container 350.

The bottom surface 352 may include a plurality of openings 353 corresponding to respective voltage applying sockets 320. The voltage applying socket 320 combined with the socket guide 10 may be inserted through respective openings 353. The socket terminal 328 of the voltage applying socket 320 may be exposed through the rear surface 356. A combining element (not shown) may be formed on a surface of the socket guide 10 facing the bottom surface 352, to physically connect the opening 353 and the socket guide 10. In an alternate embodiment, the socket guide 10 may be mounted on the bottom surface 352, and the receiving container 350 and the socket guide 10 may be physically connected to each other using the socket housing 320a of the voltage applying socket 320. The socket terminal 328, exposed through the openings 353 toward the rear surface 356, may make direct contact with and become electrically connected to the inverter terminal 372 that is formed toward the rear surface 356 by the up-down method.

In an example embodiment, the inverter cover 373 and the inverter substrate 371 are combined with each other by the up-down method. The inverter substrate 371, fixed to the inverter cover 373, is then combined with the voltage applying socket 320 and the receiving container 325 by the up-down method. Accordingly, the backlight assembly may be assembled along one direction, so that assembling the backlight assembly may be simplified and require less time.

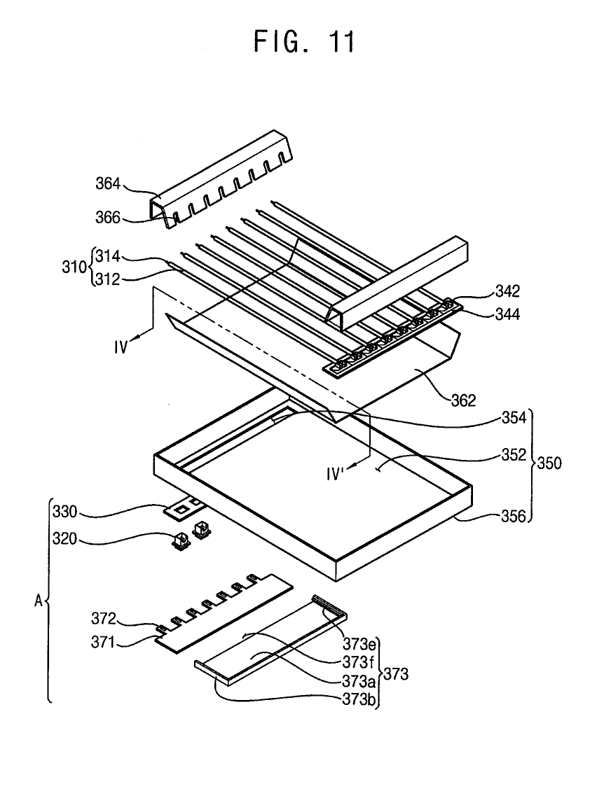

FIG. 11 is an exploded perspective view illustrating an example embodiment of a backlight assembly.

The backlight assembly of FIG. 11 may be substantially similar to the backlight assembly of FIG. 1, except for an inverter cover. Thus, the same reference numerals are used to refer to the same or like parts as those described in the first example embodiment and any further repetitive explanation concerning the above elements will be omitted.

Referring to FIG. 11, the inverter cover 373 may include a cover portion 373a, a sidewall 373b, a combining protrusion 373e, and an insertion portion 373f. The cover portion 373a may cover and protect the second surface 371b of the inverter substrate 371 on which the voltage generating circuit part is formed. The inverter terminal 372 may be formed on the first surface 371a opposite to the second surface 371b, so that the inverter terminal 372 may be electrically connected to the voltage applying socket 320.

The sidewall 373b may be connected to the cover portion 373a and may define an interior space of the inverter cover 373. The inverter cover 373 may include three sidewalls 373b, when the cover portion 373a has the rectangular shape. For example, three sidewalls 373b may include first, second and third sidewalls. The first and second sidewalls face each other, and a third sidewall connects the first sidewall with the second sidewall.

The insertion portion 373f may face the third sidewall. The insertion portion 373f may insert the inverter substrate 371 into the interior space of the inverter cover 373.

The combining protrusion 373e may be formed on the inner surface of the sidewall 373b, and may protrude from the inner surface toward the interior space. The combining protrusion 373e may have the bar shape and may be formed on the inner surface. For example, the combining protrusion 373e may be formed perpendicular to the sidewall surface of the sidewall 373b. The combining protrusion 373e may have the hexahedral shape. The combining protrusion 373e may be spaced apart from the cover portion 373a by a predetermined distance. The predetermined distance may be substantially the same as the thickness of the inverter substrate 371. A side of the inverter substrate 371 may be disposed between the combining protrusion 373e and the cover portion 373a.

Although not shown in the figures, the fixing protrusion 373d in FIG. 8 may be further formed on the outer surface of the sidewall 373b of the inverter cover 373, and the hook protrusion 385 in FIG. 8 may be formed on the rear surface 359 of the receiving container 350.

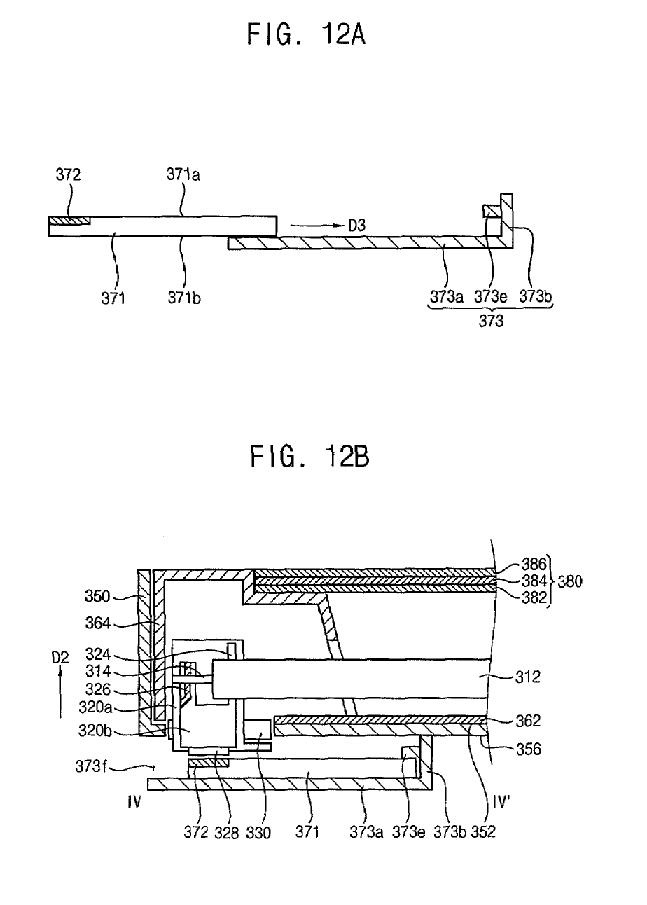

FIGS. 12A and 12B are cross-sectional views illustrating an example embodiment of a method for assembling the backlight assembly of FIG. 11.

FIGS. 12A and 12B are the cross-sectional view along a line IV-IV′ of FIG. 11. FIG. 12A is the cross-sectional view illustrating the inverter substrate and the inverter cover before assembling, and FIG. 12B is the cross-sectional view illustrating the backlight assembly after assembling.

Referring to FIG. 12A, the inverter substrate 371 may be disposed through the insertion portion 373f, and the second surface 371b faces a part of the cover portion 373a. The inverter substrate 371 may move along a third direction D3 that is from the insertion portion 373f toward the sidewall 373b. For example, the inverter substrate 371 may slide along the third direction D3. The sidewall 373b may be the third sidewall facing the insertion portion 373f.

The inverter substrate 371 may slide along the third direction D3, so that the inverter substrate 371 may be combined with the inverter cover 373 and may be inserted into the interior space of the inverter cover 373. The inverter substrate 371 inserted into the interior space may be pressed by the combining protrusion 373e along the direction toward the cover portion 373a.

Referring to FIG. 12B, the inverter substrate 371 may be inserted and fixed to the inverter cover 373 by the combining protrusion 373e. The inverter substrate 371, combined with the inverter cover 373, may then move toward the receiving container 350 along the second direction D2. Accordingly, the inverter terminal 372 may make contact with the socket terminal 328 of the voltage applying socket 320.

In an example embodiment, an inverter substrate combined with an inverter cover may be combined with a receiving container by an up-down method, so that a backlight assembly may be automatically assembled.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A backlight assembly comprising:
an inverter cover including sidewalls forming an interior space, a combining protrusion being formed on the sidewalls;
an inverter substrate received by the interior space and fixed to the inverter cover by the combining protrusion, the inverter substrate including an inverter terminal formed on a first surface of the inverter substrate facing outside;
a voltage applying socket including a socket terminal making contact with the inverter terminal, the voltage applying socket including a voltage terminal connected to the socket terminal; and
a lamp electrically connected to the voltage terminal.

2. The backlight assembly of claim 1, wherein the combining protrusion protrudes from an inner surface of the sidewall toward the interior space.

3. The backlight assembly of claim 2, wherein the combining protrusion comprises:
a guide surface protruding diagonally with respect to a sidewall surface of the sidewall; and
a fixing surface crossing the guide surface and pressing against the first surface of the inverter substrate.

4. The backlight assembly of claim 2, wherein the combining protrusion has a bar shape that protrudes vertically with respect to a sidewall surface of the sidewall.

5. The backlight assembly of claim 4, wherein the inverter cover further comprises an insertion portion formed between a pair of sidewalls facing each other, such that the inverter substrate may be inserted into the interior space through the insertion portion.

6. The backlight assembly of claim 1, wherein the voltage applying socket comprises a body portion connected to the socket terminal, with the socket terminal protruding from the body portion toward the inverter terminal.

7. The backlight assembly of claim 6, wherein a first end of the socket terminal is connected to the body portion, a second end of the socket terminal is spaced apart from the body portion, and the second end of the socket terminal contacts the body portion and the socket terminal and the inverter terminal contact each other.

8. The backlight assembly of claim 6, wherein the voltage applying socket is connected to an opposite side of the body portion that is connected to the socket terminal, and wherein the voltage applying socket comprises a voltage terminal electrically connected to the lamp.

9. The backlight assembly of claim 6, wherein the voltage applying socket covers the body portion, and further comprises a socket housing having an opening through which the socket terminal is exposed.

10. The backlight assembly of claim 6, further comprising a socket guide arranging a plurality of voltage applying sockets, wherein the socket guide comprises a socket insertion hole through which the voltage applying socket is inserted and the socket terminal is exposed.

11. The backlight assembly of claim 10, further comprising a receiving container including a bottom surface supporting the lamp, and having an opening formed through the bottom surface, the socket guide being inserted through the opening, and
wherein the inverter substrate and the inverter cover are combined with a rear surface of the receiving container opposite to the bottom surface.

12. The backlight assembly of claim 11, wherein the inverter cover further comprises a fixing protrusion formed on an outer surface of the sidewall and protruding from the outer surface of the sidewall toward outside of the inverter cover.

13. The backlight assembly of claim 12, wherein the receiving container further comprises a hook protrusion formed on the rear surface and formed around the opening, and combined with the fixing protrusion.

14. The backlight assembly of claim 1, wherein the inverter substrate comprises a voltage generator formed on a second surface of the inverter substrate opposite to the first surface, and electrically connected to the inverter terminal.

15. A method for assembling a backlight assembly, the method comprising:
fixing an inverter substrate to an inverter cover by inserting the inverter substrate into an interior space of the inverter cover;
fixing the inverter substrate which is fixed to the inverter cover to a receiving container which is combined with a voltage applying socket; and
fixing a lamp to the voltage applying socket.

16. The method of claim 15, wherein the inverter substrate is inserted into the inverter cover in a direction substantially the same as a direction in which the inverter substrate is fixed to the receiving container.

17. The method of claim 15, wherein the inverter substrate is fixed to the receiving container by:
disposing the inverter substrate combined with the inverter cover over a rear surface of the receiving container, such that an inverter terminal formed on a first surface of the inverter substrate faces the rear surface of the receiving container; and
making the inverter terminal contact a socket terminal of the voltage applying socket by moving the inverter terminal toward the rear surface of the receiving container.

18. The method of claim 15, wherein the inverter cover comprises sidewalls defining the interior space, the sidewalls comprise a combining protrusion protruding with respect to a sidewall surface of a first sidewall, and the inverter substrate is fixed to the inverter cover by inserting the inverter substrate into the inverter cover along the combining protrusion.

19. The method of claim 15, wherein the voltage applying socket comprises a body portion connected to a socket terminal, a first end of the socket terminal is connected to the body portion, a second end of the socket terminal is spaced apart from the body portion, and the inverter substrate is fixed to the receiving container by making the second end of the socket terminal contact the body portion when the socket terminal and the inverter terminal make contact with each other.

20. The method of claim 15, wherein the voltage applying socket comprises a voltage terminal and a lamp supporting portion, the voltage terminal is formed at a second end of a body portion, a socket terminal is connected to a first end of the body portion, the lamp supporting portion is formed at the second end and is spaced apart from the voltage terminal, and wherein the method further comprises:
fixing the lamp to the voltage applying socket by mounting a lamp tube connected to the lamp electrode on the lamp supporting portion by inserting a lamp electrode of the lamp to the voltage terminal.
